(19) United States
(12) Patent Application Publication
(10) Pub. No.: US 2024/0048304 A1
(43) Pub. Date: Feb. 8, 2024

(54) PPDU WITH ADJUSTABLE SUBCARRIER SPACING

(71) Applicant: Ofinno, LLC, Reston, VA (US)

(72) Inventors: Leonardo Alisasis Lanante, Reston, VA (US); Jeongki Kim, Seoul (KR); Esmael Hejazi Dinan, McLean, VA (US)

(73) Assignee: Ofinno, LLC, Reston, VA (US)

(21) Appl. No.: 18/225,772

(22) Filed: Jul. 25, 2023

Related U.S. Application Data
(60) Provisional application No. 63/394,335, filed on Aug. 2, 2022.

(51) Int. Cl. H04L 5/00; H04L 27/26

(52) U.S. Cl. CPC H04L 5/0044; H04L 27/26025

(57) ABSTRACT

A physical layer protocol data unit (PPDU) with adjustable subcarrier spacing is proposed. The PPDU may include a data field, a signal field comprising parameters for demodulating the data field, and a non-High Throughput (non-HT) long training field (L-LTF) for estimating channel equalization coefficients for the signal. The signal field includes an indication of a subcarrier spacing of the data field. A transmitter of the PPDU may select the subcarrier spacing from a set comprising a first subcarrier spacing and a second subcarrier spacing.

### CROSS-REFERENCE TO RELATED APPLICATIONS

This application claims the benefit of U.S. Provisional Application No. 63/394,335, filed Aug. 2, 2022, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 is an example that illustrates wireless medium access by a plurality of STAs in a Wireless Local Area Network (WLAN).

FIG. 4 illustrates examples of Physical Layer Protocol Data Units (PPDUs) which may be used by a STA to transmit on a wireless medium using Enhanced Distributed Channel Access (EDCA).

FIG. 5 illustrates additional examples of PPDUs which may be used by a STA to transmit on a wireless medium using EDCA.

FIG. 6 illustrates an example High Efficiency (HE) Extended Range (ER) Single User (SU) PPDU.

FIG. 7 is an example that illustrates wireless medium access using uplink (UL) Orthogonal Frequency Division Multiple Access (OFDMA) by multiple STAs.

FIG. 8 is an example that illustrates wireless medium access using UL Multi-user (MU) Multiple Input Multiple Output (MIMO) by multiple STAs.

FIG. 9 illustrates examples of Trigger Based (TB) PPDUs which may be used by a STA for UL OFDMA or UL MU MIMO.

FIG. 10 is an example that illustrates an inefficiency associated with using a TB PPDU with an Extremely High Throughput (EHT) Long Training field (EHT-LTF) having a subcarrier spacing that matches a subcarrier spacing of a Data field of the TB PPDU.

FIG. 11 is an example that illustrates an inefficiency associated with using an EHT MU PPDU with an EHT-LTF having a subcarrier spacing that matches a subcarrier spacing of a Data field of the EHT MU PPDU in an EDCA-based UL access.

FIG. 12 illustrates example Next Generation (NG) PPDUs according to embodiments of the present disclosure.

FIG. 13 illustrates an example NG PPDU according to an embodiment.

FIG. 14 illustrates an example TB PPDU according to an embodiment.

FIG. 15 illustrates an example U-SIG according to an embodiment.

FIG. 16 illustrates an example NG TB PPDU according to an embodiment.

FIG. 17 illustrates an example of channel access operation according to an embodiment.

FIG. 18 illustrates an example NG PPDU that uses Frequency Domain Duplicate (DUP) mode according to an embodiment.

FIG. 19 illustrates an example of channel access operation according to an embodiment.

FIG. 20 illustrates an example process according to an embodiment of the present disclosure.

FIG. 21 illustrates an example process according to an embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

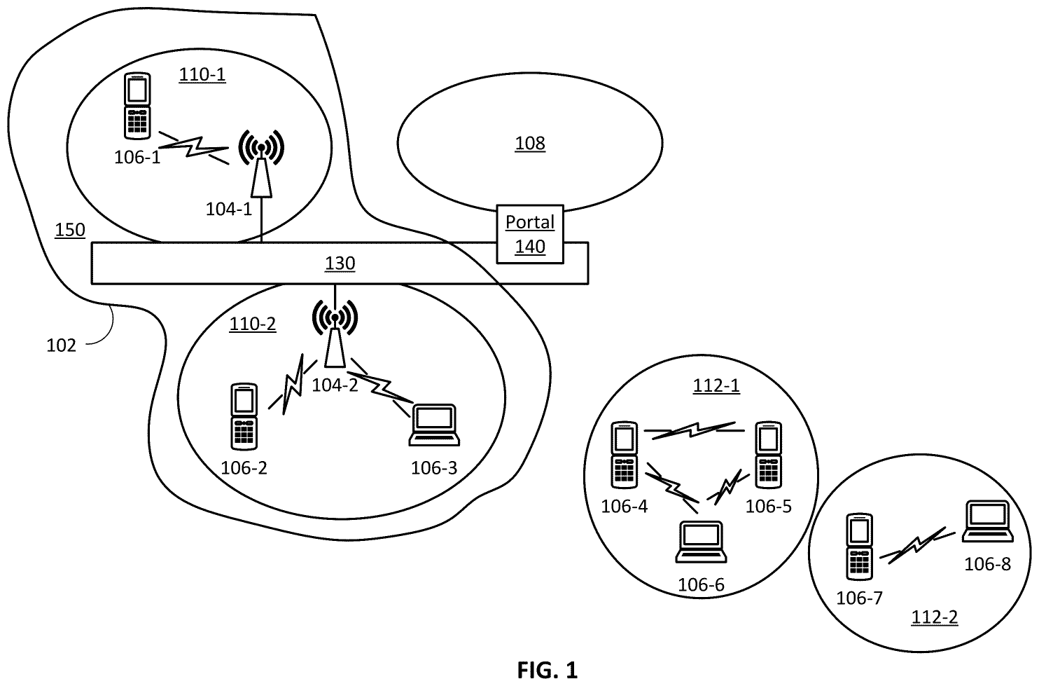

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other. DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

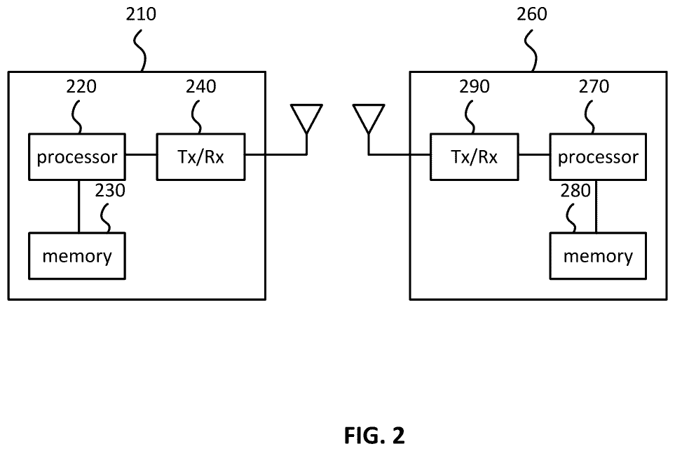

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

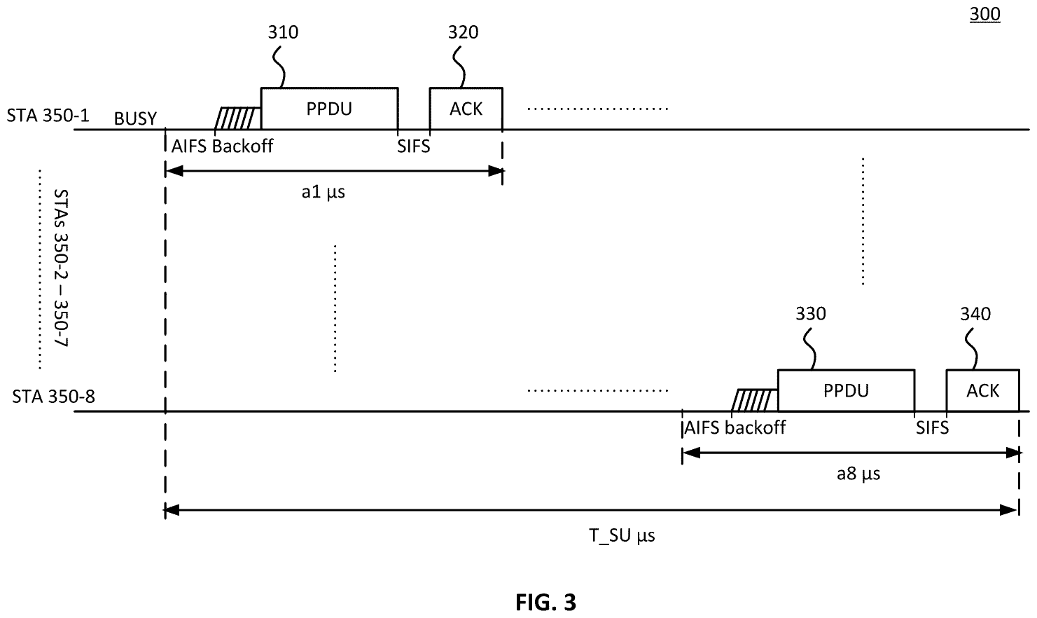

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290. FIG. 3 is an example 300 that illustrates wireless medium access by a plurality of STAs in a WLAN. As shown in FIG. 3, example 300 includes 8 STAs (350-1, . . . , 350-8) that are contending for the medium using Enhanced Distributed Channel Access (EDCA).

EDCA is a listen-before-talk access mechanism that allows exactly one STA to access a channel and to transmit a PPDU in a given time slot. Before transmission using EDCA, a STA listens to the channel for a minimum of an Arbitration Interframe Space (AIFS) duration to determine whether the channel state is IDLE. This listening time for determining whether the channel is IDLE may be followed by one or more backoff slots before the STA attempts to transmit over the channel. The number of backoff slots is chosen randomly by the STA. This reduces the probability of multiple STAs attempting to transmit at the same time, which would result in a packet detect error. If the PPDU transmitted by the STA is received successfully, for example by an AP (not shown in the figure), the AP may respond with an acknowledgement (ACK) frame after a Short Interframe Space (SIFS) duration of receiving the PPDU.

In example 300, STAs 350-1, . . . , 8 access the channel one by one using EDCA. For example, first, STA 350-1 transmits a PPDU 310 and receives an ACK frame 320 from an AP. As shown in FIG. 3, the total duration of channel access by STA 350-1 includes an AIFS duration, a backoff period, the transmission time of PPDU 310, a SIFS duration, and the transmission time of ACK frame 320. This total duration of channel access by STA 350-1 may be expressed as a1 μs. Similarly, STAs 350-2 to 350-7 each accesses the channel using EDCA and receives a corresponding ACK frame from the AP. The total duration of channel access by STAs 350-2 to 250-7 may be expressed as a2 μs-a7 μs respectively. Finally, STA 350-8 transmits a PPDU 330 and receives an ACK frame 340 within a total duration of channel access of a8 μs. Hence, channel access by STAs 350-1, . . . , 8 requires a cumulative duration T_SU μs=a1 μs+ . . . +a8 μs. This T_SU μs duration represents an average latency of channel access for each STA when 8 STAs are actively accessing the channel as in example 300.

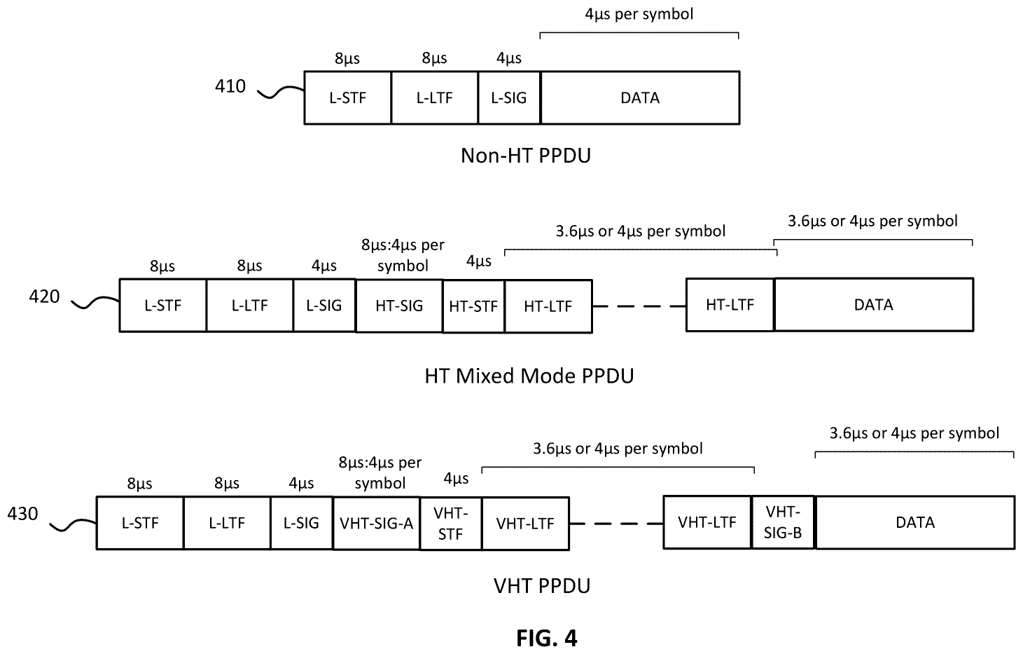

FIG. 4 illustrates examples of PPDUs which may be used by a STA to transmit on a wireless medium using EDCA, as in example 300. Non-High Throughput (non-HT) PPDU 410 may be used by STAs conforming to the IEEE 802.11a standard amendment. Non-HT PPDU 410 has a preamble duration of 20 μs. HT-Mixed Mode PPDU 420 may be used by STAs conforming to the IEEE 802.11n standard amendment. HT-Mixed Mode PPDU 420 can support MIMO to up to 4 spatial streams, which enhances spectral efficiency four folds. HT-Mixed Mode PPDU 420 has a minimum preamble duration of 35.6 μs, which may increase depending on the number of spatial streams carried by the PPDU. Very High Throughput (VHT) PPDU 430 may be used by STAs conforming to the IEEE 802.11ac standard amendment. VHT PPDU 430 can support MIMO to up to 8 spatial streams, which enhances spectral efficiency eight folds. VHT PPDU 430 has a minimum preamble duration of 39.6 μs, which may increase depending on the number of spatial streams carried by the PPDU.

As shown in FIG. 4, non-HT PPDU 410 includes a non-HT Short Training field (L-STF), a non-HT Long Training field (L-LTF), a non-HT Signal field (L-SIG), and a data field. Short training fields, such as the L-STF, are used by a receiver of the PPDU to synchronize with the carrier frequency and frame timing of a transmitter of the PPDU and to adjust the receiver signal gain. Long Training fields, such as the L-LTF, are used by the receiver of the PPDU to estimate channel coefficients in order to equalize the channel response (e.g., amplitude and phase distortion) in both Signal fields and data fields of the PPDU.

Signal fields, such as the L-SIG, contain parameters needed to demodulate the data field, which contains a payload of the PPDU. L-SIG may be equalized using the channel coefficients estimated using the L-LTF and demodulated to obtain the demodulation parameters of the data field.

The data field of non-HT PPDU 410 includes of one or more symbols each having a duration of 4 μs, where 3.2 μs carry symbol information and 0.8 μs carry a Guard Interval (GI). For non-HT PPDUs, the only supported bandwidth is 20 MHz, which is divided into 64 subcarriers. This means that the PPDU is encoded with a subcarrier spacing of 20 MHz/64 or 312.5 kHz.

As shown in FIG. 4, HT-Mixed Mode PPDU 420 includes an L-STF, an L-LTF, an L-SIG, an HT Signal field (HT-SIG) field, an HT Short Training field (HT-STF) field, one or more HT Long Training field (HT-LTF), and a data field. The HT-LTF and data fields include of one or more symbols each having a duration of 3.6 μs or 4 μs. In both cases, 3.2 μs carry symbol information while the remaining 0.4 μs or 0.8 μs carry a GI. The 0.4 μs long GI is called short GI while the 0.8 μs long GI is called regular or normal GI. For HT-Mixed Mode PPDUs, two bandwidths, 20 MHz and 40 MHz, may be supported. When the PPDU bandwidth is 20 MHz, the band is divided into 64 subcarriers. When the PPDU bandwidth is 40 MHz, the band is divided into 128 subcarriers. In both cases, subcarrier spacing of 312.5 kHz is maintained.

As shown in FIG. 4, VHT PPDU 430 includes an L-STF, an L-LTF, an L-SIG, a VHT Signal A field (VHT-SIG-A), a VHT Short Training field (VHT-STF), one or more VHT Long Training field (VHT-LTF), a VHT Signal B field (VHT-SIG-B) and a data field. The VHT-LTF and data fields of VHT PPDU 430 include of one or more symbols each having a duration of 3.6 μs or 4 μs. In both cases, 3.2 μs carry symbol information while the remaining 0.4 μs or 0.8 μs carry of the GI. The 0.4 μs long GI is called the short GI while the 0.8 μs long is called regular or normal GI. For VHT PPDUs, four bandwidths, 20 MHz, 40 MHz, 80 MHz, and 160 MHz, may be supported. When the PPDU bandwidth is 20 MHz, the band is divided into 64 subcarriers. When the PPDU bandwidth is 40 MHz, the band is divided into 128 subcarriers. When the PPDU bandwidth is 80 MHz, the band is divided into 256 subcarriers. When the PPDU bandwidth is 160 MHz, the band is divided into two 256-subcarrier 80 MHz bands. In all cases, a subcarrier spacing of 312.5 kHz is maintained.

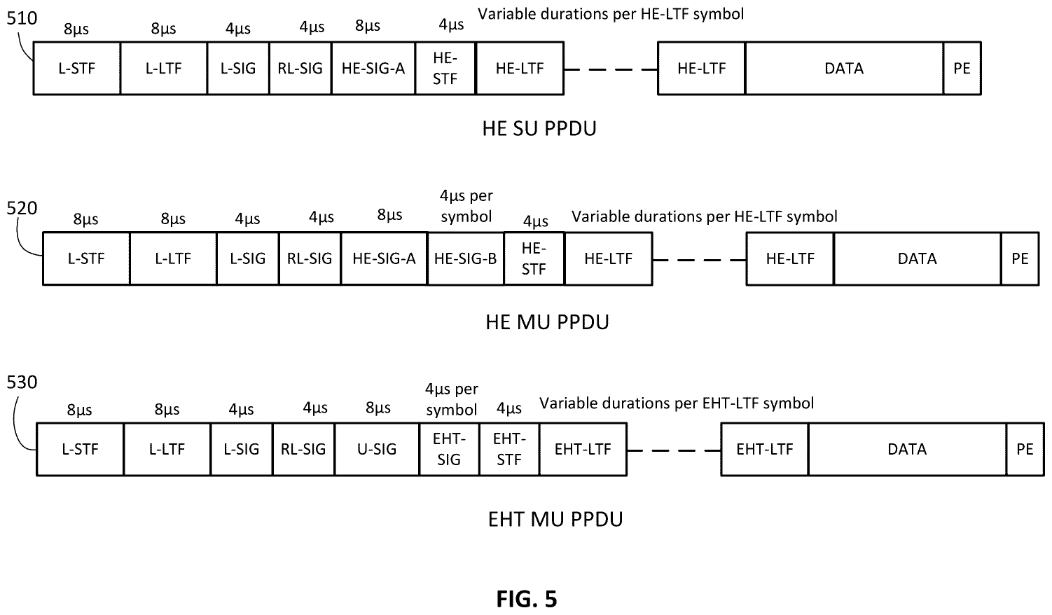

FIG. 5 illustrates additional examples of PPDUs which may be used by a STA to transmit on a wireless medium using EDCA, as in example 300. High Efficiency (HE) Single User (SU) PPDU 510 and High Efficiency (HE) Multi-user (MU) PPDU 520 may be used by STAs conforming to the IEEE 802.11ax standard amendment.

HE SU PPDU 510 supports higher spectral efficiency compared to VHT PPDU 430 due to increased subcarrier spacing and higher order modulation support. HE SU PPDU 510 has a minimum preamble duration of 44 μs.

As shown in FIG. 5, HE SU PPDU 510 includes an L-STF, an L-LTF, an L-SIG, a Repeated L-SIG (RL-SIG), a High Efficiency (HE) Signal A field (HE-SIG-A), an HE Short Training field (HE-STF) field, one or more HE Long Training field (HE-LTF), a data field, and a Packet extension (PE) field.

Similar to HE SU PPDU 510, HE MU PPDU 520 supports higher spectral efficiency compared to VHT PPDU 430. HE MU PPDU 520 also supports OFDMA. Due to denser subcarrier spacing (as in HE SU PPDU 510), HE MU PPDU 520 allows for payloads of multiple users to be multiplexed in the frequency domain in the data field. HE MU PPDU 520 supports multiplexing the payloads of up to 9 users in a single 20 MHz band. HE MU PPDU 520 has a minimum preamble duration of 47.2 μs, which may increase depending on the number of spatial streams carried by the PPDU.

As shown in FIG. 5, HE MU PPDU 520 includes an L-STF, an L-LTF, an L-SIG, an RL-SIG, an HE-SIG-A, an HE Signal B Field (HE-SIG-B), an HE-STF field, one or more HE-LTF field, a data field, and a PE field. It is noted that compared to HE SU PPDU 510, HE MU PPDU 520 further includes HE-SIG-B. HE-SIG-B contains indications per STA of RU allocations. A STA may use the indications in HE-SIG-B to locate its payload in HE MU PPDU 520.

For HE SU PPDU 510 and HE MU PPDU 520, the GI portion of the HE-LTF and data fields may be one of one of 0.8 μs, 1.6 μs, and 3.2 μs. An AP or STA may use a suitable GI duration depending on the channel conditions or capability of the target STA or AP.

For both HE SU PPDU 510 and HE MU PPDU 520, the information portion of the HE-LTF may be one of 3.2 μs, 6.4 μs, or 12.8 μs. Depending on the information portion duration, a subcarrier spacing of the HE-LTF may be one of: 312.5 kHz if the information potion is 3.2 vs, 156.25 kHz if the information portion is 6.4 μs, and 78.125 kHz if the information portion is 12.8 μs.

Contrary to the HE-LTF however, the information portion of the data field for both HE SU PPDU 510 and HE MU PPDU 520 is always 12.8 μs. Hence, a subcarrier spacing of the data field is always 78.125 kHz corresponding to the duration of the information portion being 12.8 μs.

When a 3.2 μs or 6.4 μs long HE-LTF is used by a transmitting STA to transmit HE SU PPDU 510 or HE MU PPDU 520, a receiving STA is required to interpolate the channel estimates to a subcarrier spacing resolution of 78.125 kHz to match the subcarrier spacing of the data field.

Extremely High Throughput (EHT) MU PPDU 530 may be used by STAs conforming to the IEEE 802.11be standard amendment. Like HE MU PPDU 520, EHT MU PPDU 530 supports OFDMA but up to a bandwidth of 320 MHz. EHT MU PPDU 530 further improves spectral efficiency due to a support of an even higher order modulation compared to HE SU PPDU 510 and HE MU PPDU 520 while supporting the same number of spatial streams. EHT MU PPDU 530 has a minimum preamble duration of 47.2 μs, which may increase depending on the number of spatial streams carried by the PPDU.

As shown in FIG. 5, EHT MU PPDU 520 includes an L-STF, an L-LTF, an L-SIG, an RL-SIG, a Universal Signal field (U-SIG), an EHT Signal Field (EHT-SIG), an EHT Short Training Field (EHT-STF) field, one or more EHT Long Training field (EHT-LTF), a data field, and a PE field. It is noted that according to the IEEE 802.11be standard amendment, EHT MU PPDU 530 may be used by a transmitting STA for both SU and MU transmissions.

Similar to the HE-SIG-B in HE MU PPDU 520, the EHT-SIG in EHT MU PPDU 530 contains indications per STA of RU allocations. A STA may use the indications in EHT-SIG to locate its payload in EHT MU PPDU 530.

In addition, compared to HE MU PPDU 520 and other PPDUs described so far, EHT MU PPDU 530 contains a U-SIG that ensures forward compatibility of EHT MU PPDU 530. This means that any future PPDUs that are backward compatible to IEEE 802.11be will contain the same U-SIG field and interpretation. Because of this, IEEE 802.11be STAs will be able to understand at least in part a PPDU developed in a future amendment. U-SIG may contain parameters needed to demodulate the data field of MU PPDU 530. U-SIG may be equalized using channel coefficients estimated using the L-LTF and demodulated to obtain the demodulation parameters of the data field.

Similar to HE SU PPDU 510 and HE MU PPDU 520, the GI portion of the EHT-LTF and data fields of EHT MU PPDU 530 may be one of: 0.8 μs, 1.6 μs, or 3.2 μs. An AP or STA may use a suitable GI duration depending on the channel conditions or capability of the target STA or AP.

The information portion of the EHT-LTF may be one of 3.2 μs, 6.4 μs, or 12.8 μs. Depending on the information portion duration, a subcarrier spacing of the EHT-LTF may be one of: 312.5 kHz if the information potion is 3.2 μs, 156.25 kHz if the information portion is 6.4 μs, or 78.125 kHz if the information portion is 12.8 μs.

The information portion of the data field of EHT MU PPDU 530 is always 12.8 μs. Hence, a subcarrier spacing of the data field is always 78.125 kHz corresponding to the duration of the information portion being 12.8 μs.

When a 3.2 μs long or a 6.4 μs long EHT-LTF is used by a transmitting STA to transmit EHT MU PPDU 530, a receiving STA is required to interpolate the channel estimates to a subcarrier spacing resolution of 78.125 kHz to match the data field subcarrier spacing.

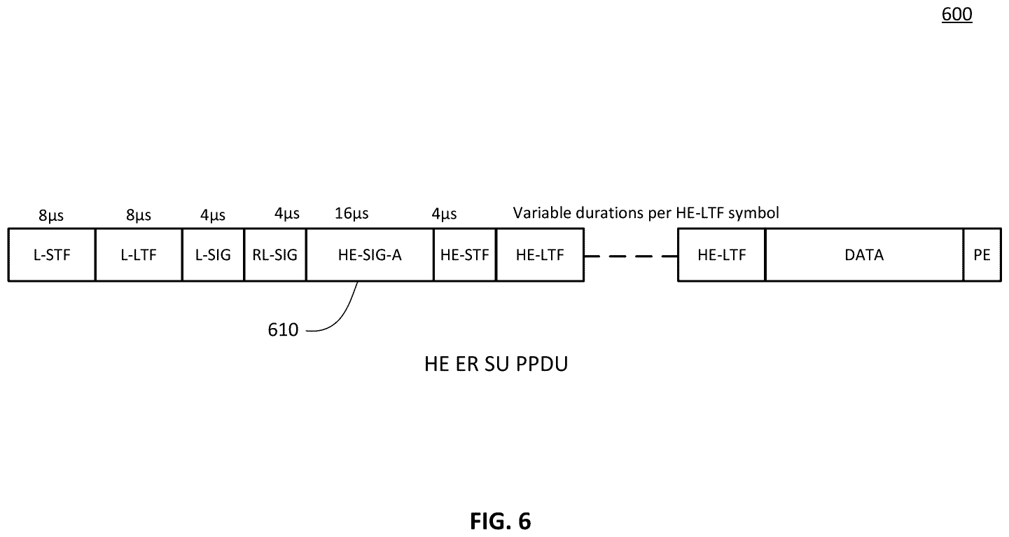

FIG. 6 illustrates an example HE Extended Range (ER) SU PPDU 600. Similar to the PPDUs discussed above, HE ER SU PPDU 600 may be used by a STA to transmit on the wireless medium using EDCA. As shown in FIG. 6, HE ER SU PPDU 600 includes an L-STF, an L-LTF, an L-SIG, an RL-SIG, an HE-SIG-A 610, an HE-STF, one or more HE-LTF, a data field, and a PE field. It is noted that compared to HE SU PPDU 510, HE ER SU PPDU 600 has an HE-SIG-A 610 that is duplicated in the time domain (16 μs long instead of 8 μs long in HE SU PPDU 510). As such, both L-SIG (duplicated using RL-SIG) and HE-SIG-A are sent in duplicates, which allows a receiving STA to combine the two copies to increase the energy of the received signal. This results in an extended range of reception and increases transmission reliability between the transmitting STA and the receiving STA.

While not currently supported in the IEEE 802.11be standard amendment, an EHT SU PPDU may also be generated by duplicating the 8 μs U-SIG field of EHT MU PPDU 530 to 16 μs.

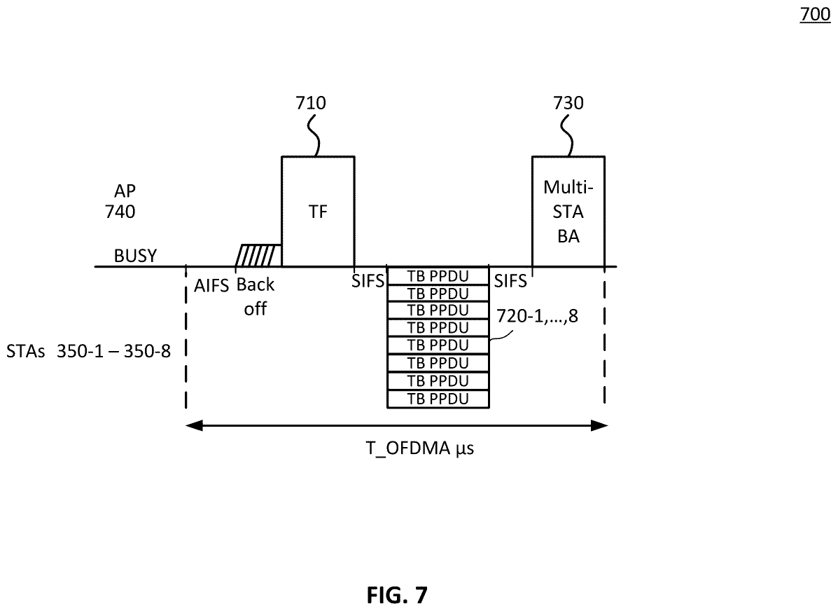

FIG. 7 is an example 700 that illustrates wireless medium access using uplink (UL) OFDMA by multiple STAs. As shown in FIG. 7, example 700 includes a plurality of STAs 350-1, . . . , 350-8 and an AP 740. In contrast to example 300 where STAs 350 access the wireless medium individually, UL OFDMA in example 700 allows STAs 350-1, . . . , 350-8 to access the channel simultaneously. This is done by having the STAs 350-1, . . . , 350-8 transmit on a number of orthogonal frequency resources.

As shown in FIG. 7, the procedure starts with AP 740 obtaining a transmit opportunity (TXOP) over the wireless medium. Using this TXOP, AP 740 transmits a Trigger Frame (TF) 710 initiating UL OFDMA transmission from STAs 350-1, . . . , 350-8. TF 710 contains indications of RUs for STAs 350-1, . . . , 350-8. On receiving TF 710, STAs 350-1, . . . , 350-8 each locates its allocated RU in TF 710 and transmits a respective Trigger Based (TB) PPDU 720 on its allocated RU, one SIFS duration after receiving TF 710. AP 740 receives TB PPDUs 720-1, . . . , 720-8 from STAs 350-1, . . . , 8 in parallel. AP 740 may transmit a multi-STA Block Ack (BA) frame 730 to acknowledge successfully received TB PPDUs 720-1, . . . , 720-8.

It is noted that, in example 700, the wireless access procedure requires a single channel contention (performed by AP 740). Hence, a single AIFS and a single backoff duration occur on the channel. This results in a decreased contention overhead. In addition, TF 710 and multi-STA BA frame 730 are broadcast frames containing aggregate information for STAs 350-1, . . . , 350-8. As such, the preamble overhead remains constant and does not scale in proportion with the number of STAs. These transmission characteristics make the total duration T_OFDMA of the transmission sequence in example 700 much lower than the total duration T_SU of example 300.

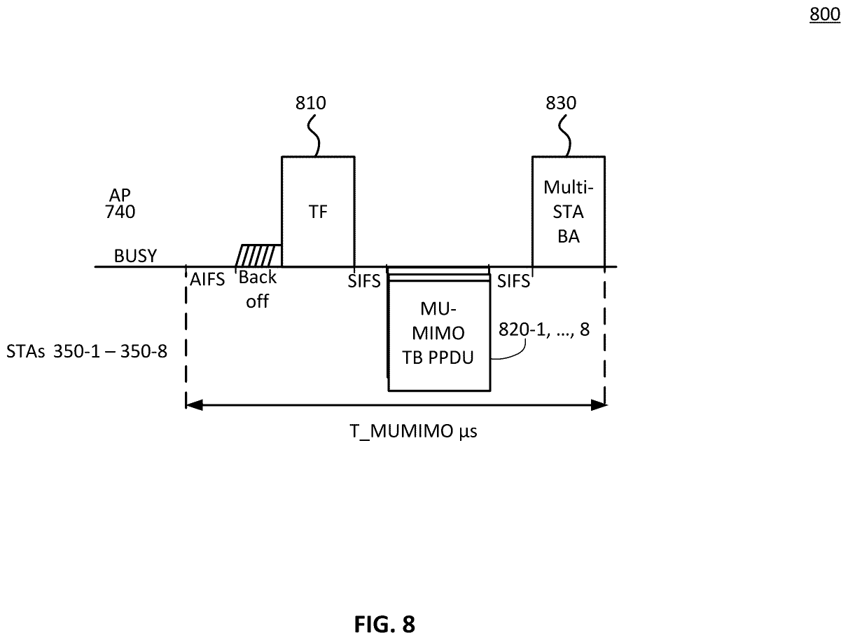

FIG. 8 is an example 800 that illustrates wireless medium access using UL MU MIMO by multiple STAs. As shown in FIG. 8, example 800 includes a plurality of STAs 350-1, . . . , 350-8 and an AP 740. Like example 700 described above, STAs 350-1, . . . , 350-8 access the wireless medium simultaneously in response to a trigger frame. However, instead of each STA 350 using a dedicated RU to transmit a respective TB PPDU, STAs 350-1, . . . , 350-8 in example 800 transmit on a same RU. The TB PPDU transmissions by STAs 350-1, . . . , 350-8 are made orthogonal in the spatial domain through the use of multiple receive antennas in AP 740.

As shown in FIG. 8, the procedure starts with an AP 740 obtaining a TXOP over the wireless medium. Using this TXOP, AP 740 transmits a TF 810 initiating UL MU MIMO transmission from STAs 350-1, . . . , 350-8. TF 810 contains indications of an RU and a stream index for each of STAs 350-1, . . . , 350-8. On receiving TF 810, STAs 350-1, . . . , 350-8 each locates its allocated RU (common to all STAs) and stream index in TF 810 and transmits a respective TB PPDU 820 on the allocated RU, one SIFS duration after receiving TF 810. AP 740 receives TB PPDUs 820-1, . . . , 820-8 from STAs 350-1, . . . , 350-8 in parallel. AP 740 may transmit a multi-STA BA frame 830 to acknowledge successfully received TB PPDUs 820.

Similar to example 700, there is a single channel contention (performed by the AP) in example 800 and hence there is a single AIFS and Backoff duration that is spent on the channel. This results in a decreased contention overhead reducing the total average latency of access for each STA. In addition, the TF and multi-STA BA frames are broadcast frames containing aggregate information for STAs 350-1, . . . , 350-8.

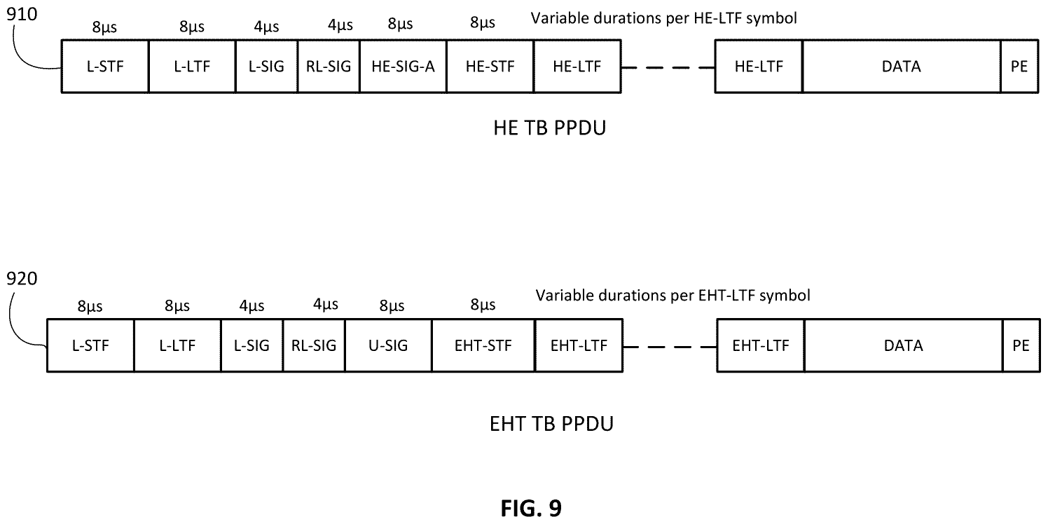

In contrast to example 700, a TB PPDU 820 in example 800 uses the entire bandwidth as AP 740 does not divide the bandwidth among the STAs. This allows the data field of TB PPDU 820 to be shorter than in TB PPDU 720 in example 700. However, the preamble of TB PPDU 820 may be longer than the preamble of TB PPDU 720 due to having extra LTFs to support multiple spatial streams (as described further below with reference to FIG. 9). Hence, depending on the amount of payload sent per STA, TB PPDU 820 or TB PPDU 720 may have a smaller overhead compared to the other. Similarly, the total duration T_MUMIMO of the transmission sequence in example 800 may be longer or shorter than the total duration T_OFDMA of the transmission sequence in example 700.

FIG. 9 illustrates examples of TB PPDUs which may be used by a STA for UL OFDMA (e.g., as in example 700) or UL MU MIMO (e.g., as in example 800).

HE TB PPDU 910 may be used by a STA conforming to the IEEE 802.11ax standard amendment. HE TB PPDU 910 shares the high spectral efficiency of HE SU PPDU 510 and HE MU PPDU 520 described in FIG. 5. As shown in FIG. 9, HE TB PPDU 910 includes an L-STF, an L-LTF, an L-SIG, a Repeated L-SIG (RL-SIG), an HE-SIG-A, an HE-STF, one or more HE-LTF, a data field, and a PE field. It is noted that compared to HE SU PPDU 510, HE TB PPDU 910 has a double duration HE-STF (8 μs instead of 4 μs). This improves time and carrier frequency synchronization needed to receive a TB PPDU such as HE TB PPDU 910.

The GI portion of the HE-LTF and data fields of HE TB PPDU 910 may be one of: 0.8 μs, 1.6 μs, or 3.2 μs. An AP or a STA may use a suitable GI duration depending on the channel conditions or capability of the target STA or AP.

The information portion of the HE-LTF of HE TB PPDU 910 may be one of: 3.2 μs, 6.4 μs, or 12.8 μs. Depending on the information portion duration, a subcarrier spacing of the HE-LTF may be one of: 312.5 kHz if the information potion is 3.2 μs, 156.25 kHz if the information portion is 6.4 μs, or 78.125 kHz if the information portion is 12.8 μs.

The information portion of the data field of HE TB PPDU 520 is always 12.8 μs. Hence, a subcarrier spacing of the data field is always 78.125 kHz corresponding to the duration of the information portion being 12.8 μs.

When a 3.2 μs long or a 6.4 μs long HE-LTF is used by a transmitting STA to transmit HE TB PPDU 910, a receiving STA is required to interpolate the channel estimates to a subcarrier spacing resolution of 78.125 kHz to match the data field subcarrier spacing.

EHT TB PPDU 920 may be used by a STA conforming to the IEEE 802.11be standard amendment. As shown in FIG. 9, EHT TB PPDU 920 includes an L-STF, an L-LTF, an L-SIG, an RL-SIG, a U-SIG, an EHT-STF, one or more EHT-LTF, a data field, and a PE field.

Similar to HE TB PPDU 910, the GI portion of the data field EHT TB PPDU 920 can be one of: 0.8 μs, 1.6 μs, or 3.2 μs. In consequence, the non-GI portion of the data Field, which has a fixed duration of 12.8 μs, may have a duration of 13.6 μs, 14.4 μs, or 16 μs. An AP or STA may use a suitable GI depending on the channel conditions or capability of the target STA or AP. The subcarrier spacing at the data field is equal to 78.125 kHz regardless of PPDU bandwidth.

The non-GI portion of the EHT-LTF of EHT TB PPDU 920 may be 3.2 μs, 6.4 μs or 12.8 μs long. This results in a subcarrier spacing of 312.5 kHz, 156.25 kHz, or 78.125 kHz, respectively. When a 3.2 μs long or a 6.4 μs long EHT-LTF is used by a transmitting STA, a receiving STA is required to interpolate the channel estimates to a subcarrier spacing resolution of 78.125 kHz to match the data field subcarrier spacing.

As mentioned above, HE-LTFs in HE PPDUs such as HE SU PPDU 510, HE MU PPDU 520, HE ER SU PPDU 60,0 and HE TB PPDU 910 may be transmitted using a subcarrier spacing of 312.5 kHz (information duration of 3.2 μs) or a subcarrier spacing of 156.25 kHz (information duration of 6.4 μs), instead of a subcarrier spacing of 78.125 kHz (information duration of 12.8 μs).

Similarly, EHT-LTFs in EHT PPDUs such as EHT MU PPDU 530 and EHT TB PPDU 920 may be transmitted using a subcarrier spacing of 312.5 kHz (information duration of 3.2 μs) or a subcarrier spacing of 156.25 kHz (information duration of 6.4 μs), instead of a subcarrier spacing of 78.125 kHz (information duration of 12.8 μs).

An HE-LTF or an EHT-LTF with a subcarrier spacing of 78.125 kHz (i.e., equal to the subcarrier spacing of the data field) increases decoding accuracy but results in a larger overhead especially when the PPDU includes several HE-LTFs or EHT-LTFs. Using an HE-LTF or an EHT-LTF with a larger subcarrier spacing reduces the overhead. However, a larger subcarrier spacing may require an interpolation circuitry at the receiver to generate intermediate channel estimates for subcarriers present in the data field that are not present in the HE-LTF or EHT-LTF. In addition to increasing receiver complexity and cost, an interpolation circuit may degrade performance due to processing noise added by the interpolation step.

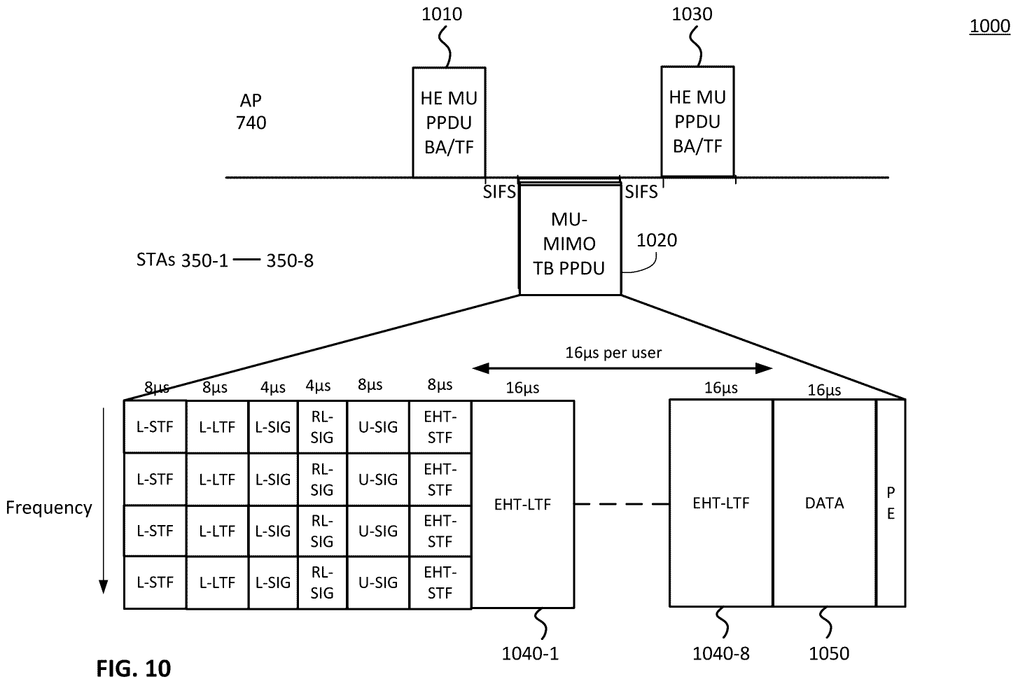

FIG. 10 is an example 1000 that illustrates an inefficiency associated with using a TB PPDU with an EHT-LTF having a subcarrier spacing that matches a subcarrier spacing of the Data field of the TB PPDU. As shown in FIG. 10, example 1000 includes an AP 740 and a plurality of STAs 350-1, . . . , 8.

In an example, AP 740 may transmit an HE MU PPDU 1010 to STAs 350-1, . . . , 350-8. In an example, to reduce protocol overhead, HE MU PPDU 1010 may aggregate within the same MU PPDU both TFs and BA frames. For example, HE MU PPDU 1010 may include a plurality of BA frames transmitted respectively in response to a plurality of TB PPDUs (not shown in FIG. 10) transmitted by STAs 350-1, . . . , 350-8. In addition, HE MU PPDU 1010 may include a plurality of TFs soliciting UL frames from STAs 350-1, . . . , 350-8.

STAs 350-1, . . . , 350-8 may respond simultaneously to HE MU PPDU 1010 by each transmitting an MU MIMO TB PPDU 1020. In an example, MU MIMO TB PPDU 1020 may have an 80 MHz bandwidth. As shown in FIG. 8, a STA 350 may duplicate four times over frequency each of fields L-STF, L-LTF, L-SIG, RL-SIG, U-SIG, and EHT-STF to fill out the MHz bandwidth. EHT-LTFs 1040 and a data field 1050 of PPDU 1020 may fill out the entire 80 MHz bandwidth and are not duplicated over frequency. The number of EHT-LTFs transmitted by the STA (in time) is based on the number of users accessing the channel using MU MIMO TB PPDU 1020. In example 1000, MU MIMO TB PPDU 1020 includes eight EHT-LTFs 1040-1, . . . , 1040-8.

AP 740 may acknowledge MU MIMO TB PPDU 1020 by transmitting HE MU PPDU 1030. Like HE MU PPDU 1010, HE MU PPDU 1030 may aggregate both TFs (soliciting further UL frames from STAs 350-1, . . . , 350-8) and BA frames (acknowledging the TB PPDUs contained in MU MIMO TB PPDU 1020).

In an example 1000, it is assumed that PPDUs 1010, 1020, and 1030 are all transmitted using a bandwidth of 80 MHz. Further, EHT-LTFs 1040-1, . . . , 1040-8 of MU MIMO TB PPDU 1020 use the same subcarrier spacing (78.125 kHz) as data field 1050 of TB PPDU 1020. As such, each EHT-LTF 1040-1, . . . , 1040-8 has a 16 μs duration.

As shown in FIG. 10, the total access latency of a STA 350 is equal to the combined duration of an HE MU PPDU (e.g., 1010), a SIFS duration, and a TB PPDU (e.g., 1020). To reduce the access latency, the HE MU PPDU may be replaced with a single spatial stream EHT MU PPDU in order to avoid a long string of EHT-LTFs in the time domain. On the other hand, the same cannot be done with MU-MIMO TB PPDU 1020, which is a multiple spatial stream PPDU. This results in a large overhead due to the EHT-LTFs 1040 of TB PPDU 1020. For example, in the case of 8 UL STAs, the total overhead due to the EHT-LTFs is 128 μs. In some scenarios, such as real time control where the payload can fit in a single 16 μs data field, a total EHT-LTF duration of 128 μs per 8 STA is highly inefficient.

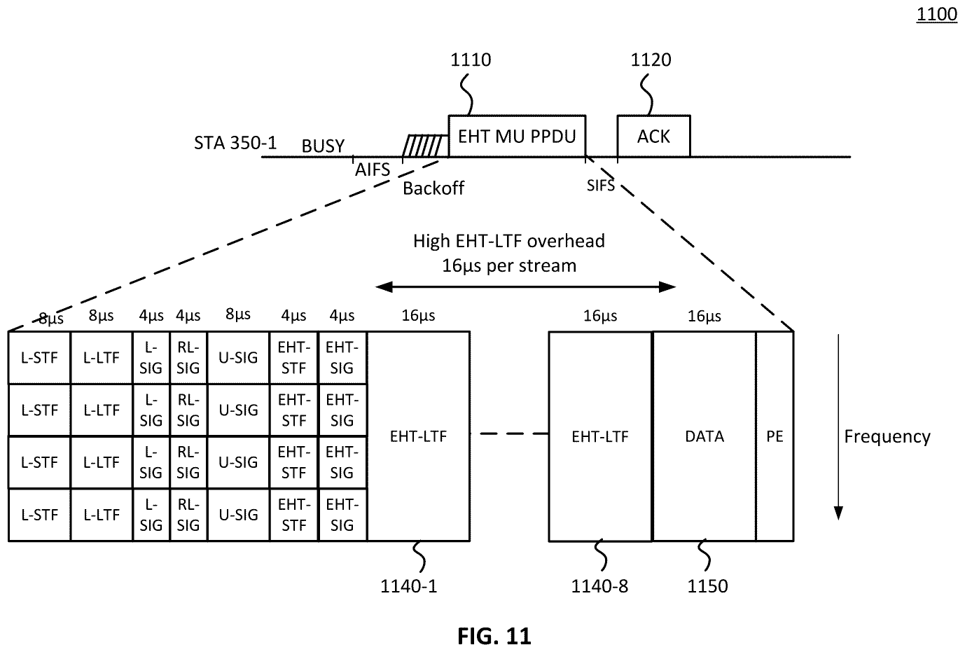

FIG. 11 is an example 1100 that illustrates an inefficiency associated with using an EHT MU PPDU with an EHT-LTF having a subcarrier spacing that matches a subcarrier spacing of a data field of the EHT MU PPDU in an EDCA-based UL access.

In example 1100, a STA 350-1 accesses the channel using EDCA using an 8-stream EHT MU PPDU 1110 with an 80 MHz PPDU bandwidth. As shown in FIG. 11, EHT MU PPDU 1110 includes a plurality of EHT-LTFs 1140-1, . . . , 1140-8 and a data field 1150. The use of 8-stream MIMO and an 80 MHz wide bandwidth may reduce access latency by reducing the duration of data field 1150. To transmit an EHT MU PPDU with an 8-stream MIMO PPDU, STA 350-1 may have 8 active antennas each coupled to a respective independent radio circuitry. As shown in FIG. 11, when EHT MU PPDU 1110 is successfully received by an AP (not shown in the figure), the AP may acknowledge PPDU 1110 by transmitting an ACK 1120 after a SIFS duration.

In example 1100, it is assumed that EHT-LTFs 1140-1, . . . , 1140-8 of EHT MU PPDU 1110 use the same subcarrier spacing (78.125 kHz) as the data field 1150 of EHT MU PPDU 1110. As such, each EHT-LTF 1140-1, . . . , 1140-8 has a 16 μs duration.

In example 1100, the total access latency of STA 350-1 is equal to the combined duration of an AIFS, a Backoff duration, two SIFSs, EHT MU PPDU 1110, and ACK 1120. This duration however is governed by the transmission time of EHT MU PPDU 1110 and specifically the 16 μs duration of each of EHT-LTFs 1140-1, . . . , 1140-8 of EHT MU PPDU 1110. This results in a large overhead. For example, in the case of 8 streams, the total overhead due to the EHT-LTFs is 128 μs. In some scenarios, such as real time control where the payload can fit in a single 16 μs data field, a total EHT-LTF duration of 128 μs per 8 streams is highly inefficient.

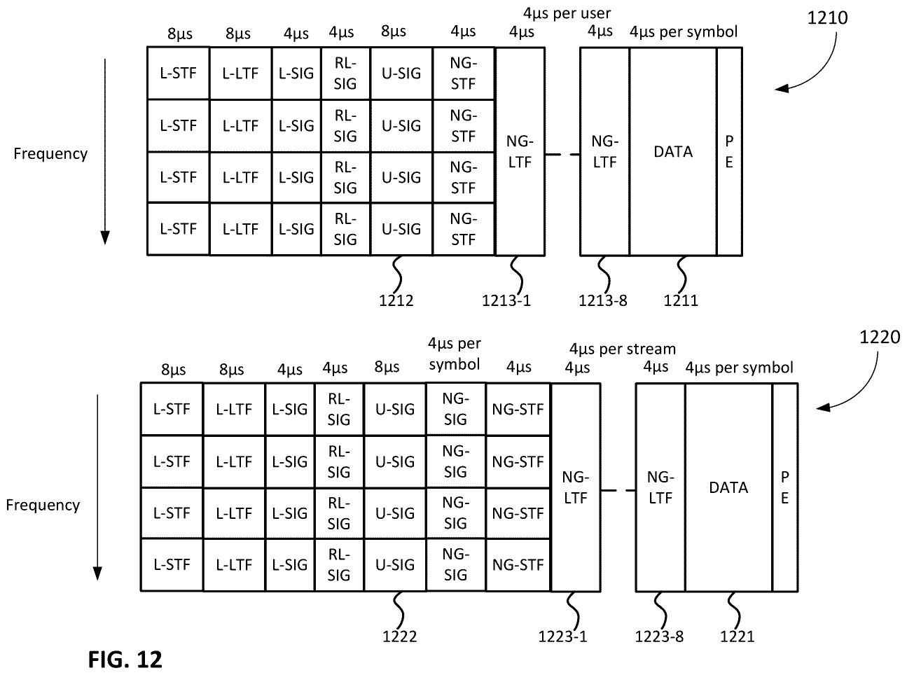

FIG. 12 illustrates example Next Generation (NG) PPDUs 1210 and 1220 according to embodiments of the present disclosure.

NG TB PPDU 1210 may reduce preamble overhead when used in an UL MU MIMO scenario including a high number of transmitting STAs. As shown in FIG. 12, NG TB PPDU 1210 may include an L-STF, an L-LTF, an L-SIG, an RL-SIG, a U-SIG 1212, an NG Short Training field (NG-STF), one or more NG Long Training fields (NG-LTFs) 1213-1, . . . , 1213-8, a data field 1211, and a PE field. In an embodiment, NG-LTFs 1213-1, . . . , 1213-8 may have a subcarrier spacing that is equal to the subcarrier spacing of data field 1211 of PPDU 1210. NG-LTFs 1213-1, . . . , 1213-8 may be used by the receiver of PPDU 1210 to estimate channel coefficients in order to equalize the channel response (e.g., amplitude and phase distortion) of data field 1211 when the subcarrier spacing of data field 1211 is different from the subcarrier spacing of the L-LTF.

As shown in FIG. 12, NG-LTFs 1213 and data field 1211 of NG TB PPDU 1210 have the same duration per symbol, reflecting equal subcarrier spacing. This has the advantage of not requiring additional circuitry to interpolate information from missing subcarriers in NG-LTFs 1213 or data field 1211. Further, instead of having NG-LTFs 1213 match the 78.125 kHz subcarrier spacing of the data field as in EHT and HE PPDUs, NG TB PPDU 1210 uses a subcarrier spacing of 312.5 kHz for NG-LTFs 1213 and data field 1211. U-SIG 1212 ensures that NG PPDU 1210 is backward and forward compatible with past and future PPDU formats that similarly contain a U-SIG.

In an embodiment, the information portion of NG-LTFs 1213 and data field 1211 may be set to 3.2 μs and the GI portion may be set to 0.8 μs similar to the information portion and GI portion duration of the L-SIG and U-SIG. In another embodiment, the information portion of NG-LTFs 1213 and data field 1211 may be 3.2 μs but the GI portion may be a value less than 0.8 μs (e.g., 0.4 μs or 0.2 μs). In such an embodiment, the payload size that can be transmitted by the TB PPDU will be higher at the expense of additional circuitry in the receiver to detect variable symbol durations.

In order to lower the preamble overhead, NG TB PPDU 1210 may use an information portion duration of 3.2 μs for both NG-LTFs 1213 and data field 1211. The benefit of this embodiment is that in an UL MU MIMO transmission, such as example 1000, an additional NG-LTF to support an additional user only increases the preamble duration by 4 μs instead of the 16 μs (assuming a GI portion duration of 0.8 μs) for both HE TB PPDU 910 and EHT TB PPDU 920.

NG MU PPDU 1220 may reduce preamble overhead when used in a scenario including transmission of a high number of spatial streams. As shown in FIG. 12, NG MU PPDU 1220 may include an L-STF, an L-LTF, an L-SIG, an RL-SIG, a U-SIG 1222, an NG Signal field (NG-SIG), an NG Short Training field (NG-STF), one or more NG Long Training fields (NG-LTFs) 1223-1, . . . , 1223-8, a data field 1221, and a PE field. In an embodiment, NG-LTFs 1223-1, . . . , 1223-8 may have a subcarrier spacing that is equal to the subcarrier spacing of data field 1221 of PPDU 1220. NG-LTFs 1223-1, . . . , 1223-8 may be used by the receiver of PPDU 1220 to estimate channel coefficients in order to equalize the channel response (e.g., amplitude and phase distortion) of data field 1221 when the subcarrier spacing of data field 1221 is different from the subcarrier spacing of the L-LTF.

In an embodiment, the NG-SIG may contain parameters needed to demodulate the data field 1221 of NG MU PPDU 1220. NG-SIG may be equalized using channel coefficients estimated using the L-LTF and demodulated to obtain the demodulation parameters of the data field.

As shown in FIG. 12, each of NG-LTFs 1223 along with data field 1221 of NG MU PPDU 1220 have the same subcarrier spacing. This has the advantage of not requiring additional circuitry to interpolate information from missing subcarriers in NG-LTFs 1223 or Data field 1221. Further, instead of having NG-LTFs 1223 match the 78.125 kHz subcarrier spacing of data field 1221 as in EHT and HE PPDUs, NG MU PPDU 1220 uses a subcarrier spacing of 312.5 kHz for NG-LTFs 1223 and data field 1211 U-SIG 1222 ensures that NG PPDU 1220 is backward and forward compatible with past and future PPDU formats that similarly contain a U-SIG.

In an embodiment, the information portion of NG-LTFs 1223 and data field 1221 may be set to 3.2 μs and the GI portion may be set to 0.8 μs similar to the information portion and GI portion duration of the L-SIG and U-SIG. In another embodiment, the information portion of NG-LTFs 1223 and data field 1221 may be 3.2 μs but the GI portion may be a value less than 0.8 μs (e.g., 0.4 μs, 0.2 μs). In such an embodiment, the payload size that can be transmitted by the NG MU PPDU will be higher at the expense of additional circuitry in the receiver to detect variable symbol durations.

In order to lower the preamble overhead, NG MU PPDU 1220 may use an information portion duration of 3.2 μs for both NG-LTFs 1223 and Data field 1221. The benefit of this embodiment is that in a MIMO transmission, such as example 1100, an additional NG-LTF to support an additional stream only increases the preamble duration by 4 μs instead of the 16 μs (assuming a GI portion duration of 0.8 μs) for HE SU PPDU 510, HE MU PPDU 520 and EHT MU PPDU 530.

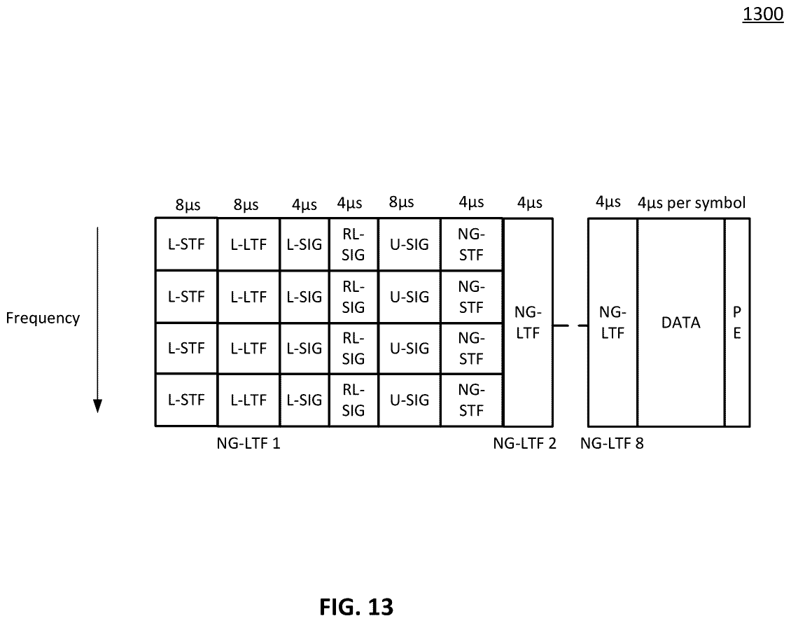

FIG. 13 illustrates an example NG PPDU 1300 according to an embodiment. In NG PPDU 1300, the L-LTF is reused as the first NG-LTF (NG-LTF 1) of the TB PPDU. NG PPDU 1300 may thus only require 7 NG-LTFs to support the 8-user transmission described in example 800. The reason for this is that since the NG-LTF and L-LTF have the same subcarrier spacing of 312.5 kHz, the L-LTF can be reused as the first of the needed 8 NG-LTFs required to support 8 users. Hence, in contrast to both HE TB PPDU 910 and EHT TB PPDU 920 which would require an overhead of 168 μs to support example 800, NG TB PPDU 1300 may require an overhead of only 64 μs.

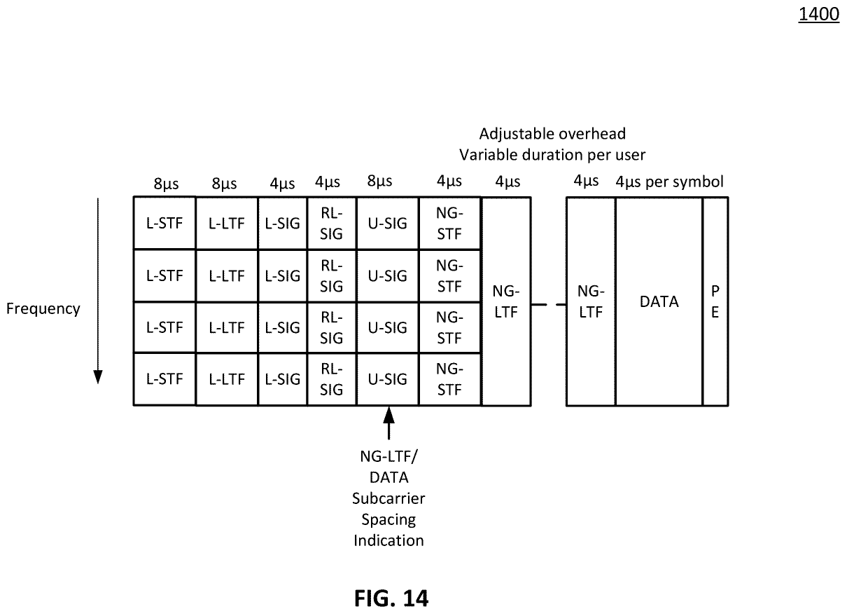

FIG. 14 illustrates an example TB PPDU 1400 according to an embodiment. In an embodiment, TB PPDU 1400 may have an adjustable preamble overhead. Specifically, NG TB PPDU 1400 may have an adjustable subcarrier spacing for the NG-LTF and data fields. This may result in NG-LTF and data symbols that are greater than or equal to 4 μs.

In order to allow a receiving STA to decode an adjustable subcarrier spacing, NG TB PPDU 1400 may contain an indication in its U-SIG field of the subcarrier spacing used for the NG-LTF and data fields. The subcarrier spacing indication allows NG TB PPDU 1400 to implement a low preamble overhead TB PPDU such as NG TB PPDU 1210 with a data field subcarrier spacing of 312.5 kHz, a high preamble overhead TB PPDU (yet spectrally more efficient) such as HE TB PPDU 910 and EHT TB PPDU 920 with a data field subcarrier spacing of 78.125 kHz, or a TB PPDU with an arbitrary data field subcarrier spacing (e.g., 156.25 kHz, 234.375 kHz, 625 kHz, or 39.0625 kHz).

In an embodiment, a STA may decide to use a narrow subcarrier spacing (for the NG-LTF and data fields) in NG TB PPDU 1400 to allow more users in UL OFDMA such as in example 700. Alternatively, the STA may decide to use a wider subcarrier spacing (for the NG-LTF and data fields) in NG TB PPDU 1400 to reduce the preamble overhead in an UL MU MIMO such as in example 800. The decision by the STA to use a value of subcarrier spacing may also depend on the capabilities of a receiving STA.

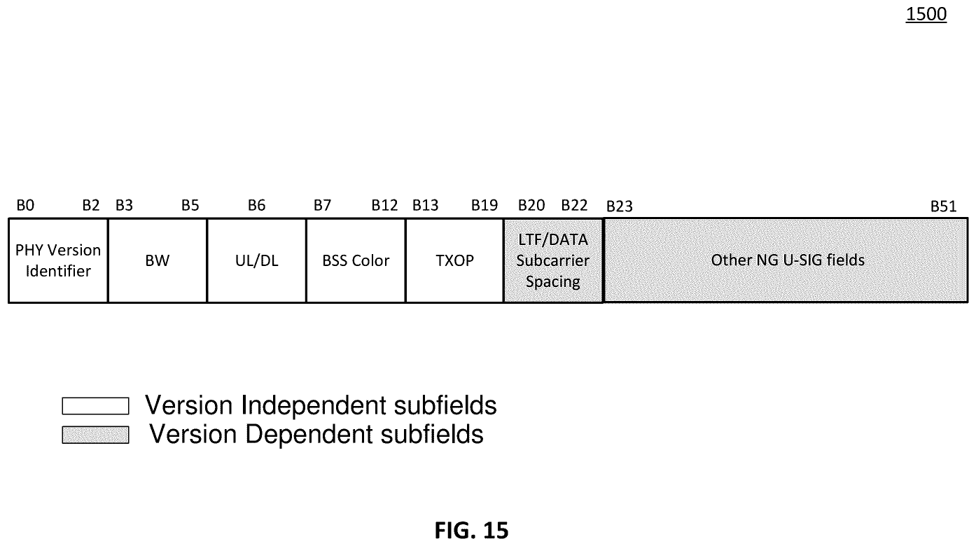

FIG. 15 illustrates an example U-SIG 1500 according to an embodiment. As shown in FIG. 15, U-SIG 1500 contains both version independent and version dependent subfields. The version independent subfields are located from bit B0 to B19 while the version dependent subfields are located from bits B20 to B51.

The version independent subfields are subfields that are consistent in location and interpretation across various IEEE 802.11 PHY layer versions. The purpose of version independent subfields is to achieve better coexistence among IEEE 802.11 PHYs that are defined for the 2.4, 5, and 6 GHz spectrums from the EHT PHY specification onwards.

The PHY Version Identifier subfield is one of the version independent subfields in U-SIG 1500. The purpose of the PHY Version Identifier is to facilitate autodetection for IEEE 802.11 PHY layers that are defined for 2.4, 5, and 6 GHz spectrum from the EHT PHY specification onwards. The value of this subfield is used to identify the exact PHY version of the EHT PPDU comprising U-SIG 1500.

Other version independent subfields include a Bandwidth (BW) subfield, which indicates the PPDU bandwidth, an Uplink/Downlink (UL/DL) subfield, which indicates whether the PPDU is an uplink or a downlink PPDU, a BSS Color subfield, which indicates the BSS Color of the PPDU, and a TXOP subfield, which indicates a duration of a TXOP in which the PPDU is transmitted.

Version dependent subfields in U-SIG 1500 are subfields specific to the IEEE 802.11 PHY version indicated in the PHY Version Identifier subfield. As shown in FIG. 15, U-SIG 1500 uses bit B20 to bit B22 for an LTF/DATA Subcarrier Spacing indication. The LTF/DATA Subcarrier Spacing indication may indicate a total of 8 subcarrier spacing values that the NG-LTF and data fields of the PPDU can use.

In an embodiment, U-SIG 1500 may alternatively signal a duration of the NG-LTF and data fields instead of the subcarrier spacing. Combining this with an indication of a GI duration, a receiving STA is able to determine a value of a subcarrier spacing used to generate the NG-LTF and data fields. In another embodiment, U-SIG 1500 may signal a PPDU subtype that uses a specific subcarrier spacing. Hence, a receiving STA may use a look-up table of PPDU subtype to subcarrier spacing to determine the subcarrier spacing used to generate the NG-LTF and data fields.

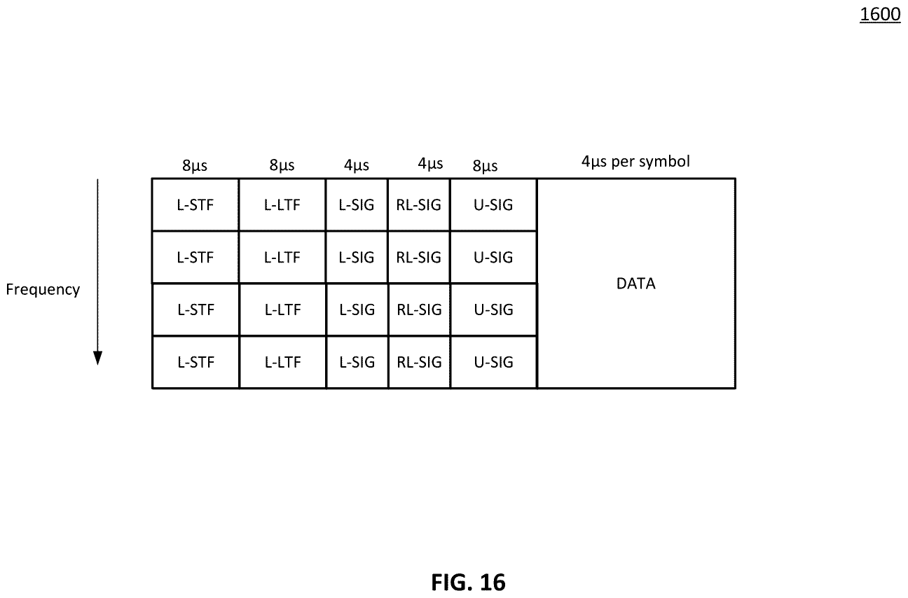

FIG. 16 illustrates an example NG TB PPDU 1600 according to an embodiment. NG TB PPDU 1600 may be used in a non-UL MU MIMO wireless system. As shown in FIG. 16, NG TB PPDU 1600 includes an L-STF, an L-LTF, an L-SIG, a Repeated L-SIG (RL-SIG), a Universal Signal field (U-SIG), and a data field. As TB PPDU 1600 does not support UL MIMO, NG TB PPDU 1600 does not include an NG-LTF, which greatly decreases the preamble overhead. In addition, the data field of NG TB PPDU 1600 may always use a subcarrier spacing of 312.5 kHz.

As shown in FIG. 16, NG TB PPDU 1600 has a preamble overhead of only 32 μs making it suitable for very low latency applications such as wireless industrial control and wireless virtual reality. A receiving STA uses the L-LTF to decode the data field. L-LTF is enough for decoding as UL MU MIMO is not supported.

NG TB PPDU 1600 may also support UL MU transmission using UL OFDMA. It is noted that compared to HE TB PPDU 910 and EHT TB PPDU 920, which have a subcarrier spacing of 78.125 KHz, the number of users that NG TB PPDU 1600 may accommodate may be less due to the larger subcarrier spacing.

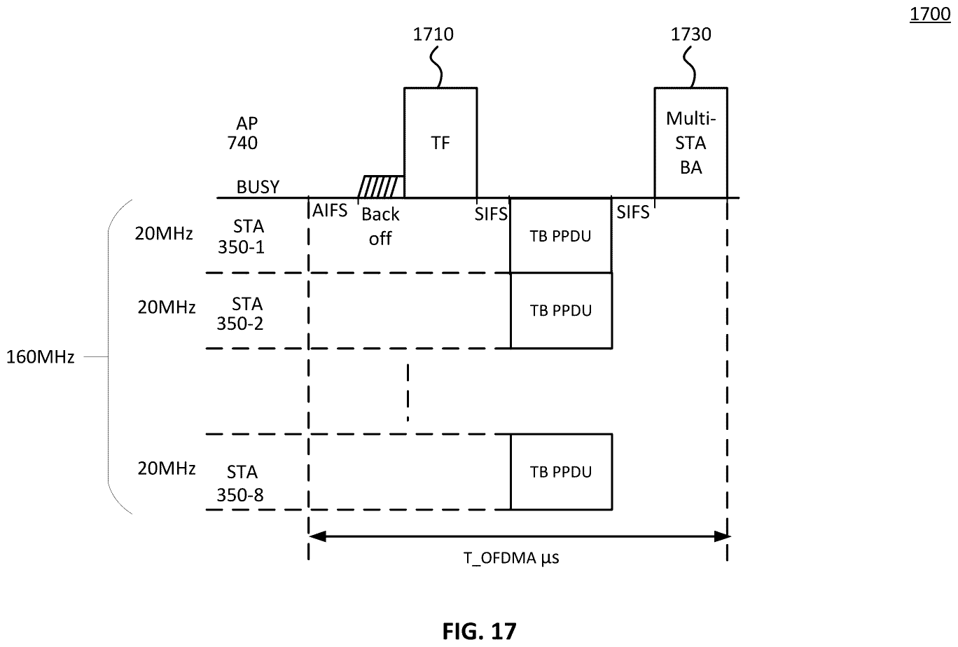

FIG. 17 illustrates an example 1700 of channel access operation according to an embodiment. As shown in FIG. 17, example 1700 includes an AP 740 and a plurality of STAs 350-1, . . . , 8.

Example 1700 starts with AP 740 contending for the channel using EDCA. AP 740 then transmits a TF 1710 initiating UL OFDMA transmissions from STAs 350-1, . . . , 350-8. TF 1710 contains indications of RUs that are allocated for each of STAs 350-1, . . . , 350-8. On receiving TF 1710, STAs 350-1, . . . , 8 each confirms its RU allocation and transmits an NG TB PPDU, according to NG TB PPDU 1600 described above, using its allocated RU. AP 740 may transmit a multi-STA BA frame 1730 to acknowledge successfully received TB PPDUs.

In example 1700, UL OFDMA allows STAs 350-1, . . . , 350-8 to access the channel simultaneously similar to example 700. Each STA 350 in example 1700 transmits with an RU equal to 20 MHz. For 8 users, a 160 MHz PPDU bandwidth is required. As the preamble duration of NG TB PPDU 1600 is much shorter than that of HE TB PPDU 910 or EHT TB PPDU 920, the total sequence duration T_OFDMA in example 1700 is lower than the total sequence duration T_OFDMA in example 700.

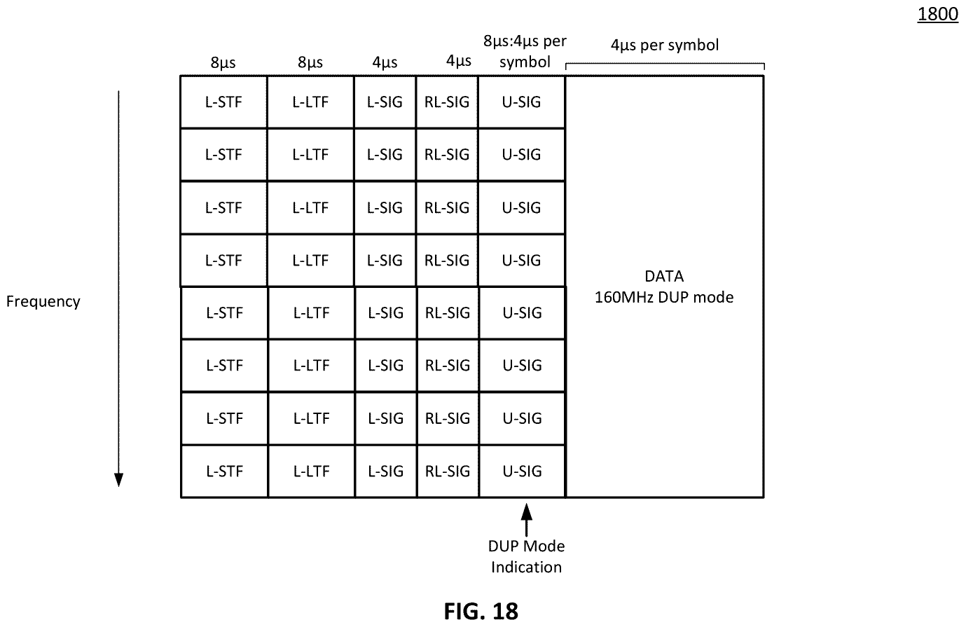

FIG. 18 illustrates an example NG PPDU 1800 that uses a Frequency Domain Duplicate (DUP) mode according to an embodiment. A DUP mode is a transmission mode introduced in the IEEE 802.11be standard amendment in which the data portion of a PPDU is duplicated in frequency. This feature allows a STA to modulate the same set of information on two or more subcarriers.

In an embodiment, as shown in FIG. 18, the DUP mode may be signaled in the U-SIG of NG PPDU 1800. For example, the DUP mode may be signaled in one of the version dependent fields described above with reference to U-SIG 1500 in FIG. 15.

Similar to NG TB PPDU 1600, NG PPDU 1800 has a preamble overhead of 32μs and supports a subcarrier spacing of 312.5 kHz. NG PPDU 1800 is an MU PPDU and hence may be transmitted without the need of receiving a prior TF.

NG MU PPDU 1800 may be used in a scenario where only EDCA is possible as a channel access mechanism such as example 300. In contrast to PPDU formats such as non-HT PPDU 410, HT Mixed Mode PPDU 420, and VHT PPDU 430, NG PPDU 1800 allows for advanced techniques such as the use of a 320 MHz bandwidth, preamble puncturing, and DUP mode.

The L-STF, L-LTF, L-SIG, RL-SIG and U-SIG of NG PPDU 1800 are each a 20 MHz OFDM symbol and are each duplicated on every subchannel component of PPDU 1800. Each symbol of the data field on the other hand may be encoded using a particular duplicate factor used by the STA. For example, the data information may be generated as a 20 MHz symbol and duplicated 8 times to fill the 160 MHz PPDU bandwidth. In another embodiment, the data information may be generated as a 40 MHz symbol and duplicated 4 times to fill the 160 MHz bandwidth.

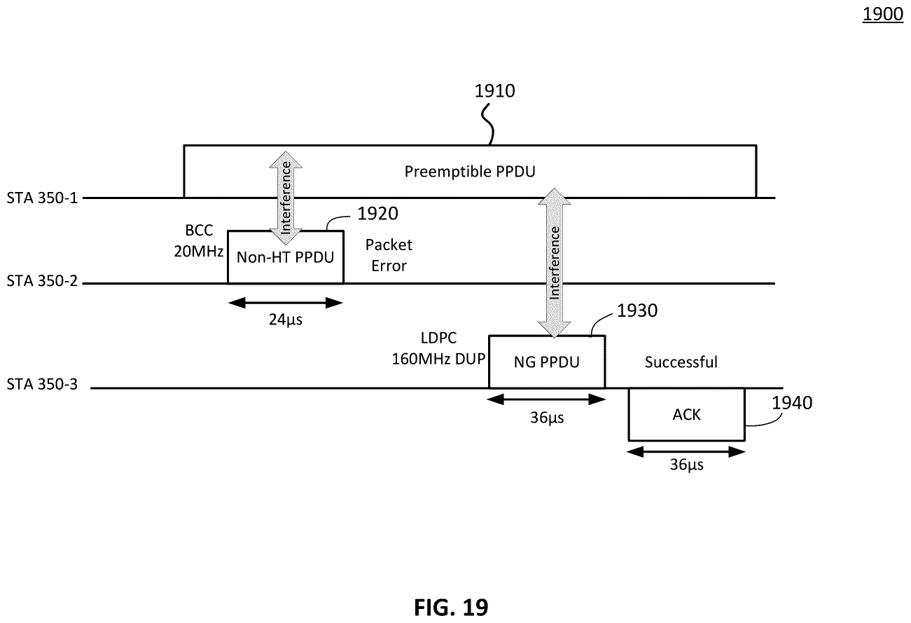

FIG. 19 illustrates an example 1900 of channel access operation according to an embodiment. As shown in FIG. 19, example 1900 includes STAs 350-1, 350-2, and 350-3 that are contending for channel access.

In an example, STA 350-1 may succeed in obtaining a TXOP. Knowing that its transmission has a low priority, STA 350-1 may transmit a pre-emptible PPDU 1910. A pre-emptible PPDU is a PPDU that allows another PPDU to pre-empt it. To minimize performance loss due to pre-emption, a pre-emptible PPDU may have a built-in mechanism to reduce the effect of high interference. In an embodiment, STA 350-1 may restrict pre-empting PPDUs up to a certain point in PPDU 1910 and up to a certain duration of the pre-empting PPDU.

In an example, while STA 350-1 transmits PPDU 1910, STA 350-2 may transmit a pre-empting non-HT PPDU 1920. Non-HT PPDU 1920 may be short enough that it results in minimal impact on the transmission of PPDU 1910 by STA 350-1. However, PPDU 1910 may cause significant interference to non-HT PPDU 1920. One reason may be that non-HT PPDU 1920, while having a low preamble overhead and being as short as 24 μs, does not support mechanisms that improve PPDU reception (e.g., DUP mode in EHT PPDU, Low Density Parity Check Code in HT Mixed Mode PPDU, VHT PPDU, HE PPDU and EHT PPDU). Thus, as shown in example 1900, a packet error may result at the receiving STA of non-HT PPDU 1920. STA 350-2 may attempt to re-transmit non-HT PPDU 1920 after the end of transmission of pre-emptible PPDU 1910 to avoid interference from PPDU 1910.

In an example, STA 350-3 may transmit an NG DUP Mode PPDU 1930 with a duration of 36 μs. NG DUP Mode PPDU 1930 may have a format according to NG PPDU 1800 described above. It is noted that 36 μs is the shortest NG PPDU duration based on NG DUP Mode PPDU 1800. While being 12 μs longer than non-HT PPDU 1920, NG PPDU 1930 uses both LDPC and DUP Mode, greatly enhancing its reliability against interference due to pre-emptible PPDU 1910. As shown in example 1900, NG PPDU 1930 is decoded successfully by its receiving STA. The receiving STA may acknowledge successful reception of NG PPDU 1930 by transmitting an ACK 1940 to STA 350-3.

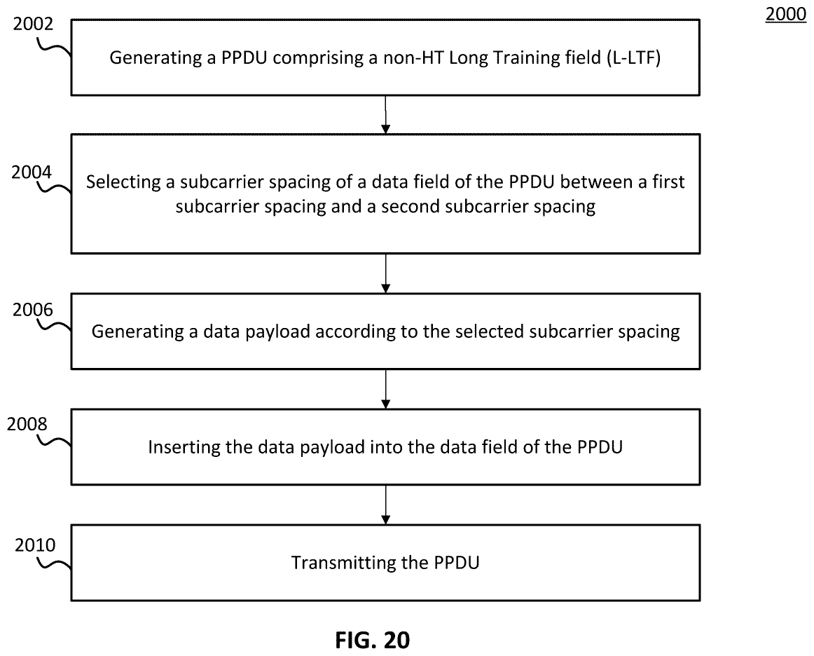

FIG. 20 illustrates an example process 2000 according to an embodiment of the present disclosure. Example process 2000 is provided for the purpose of illustration only and is not limiting of embodiments. Example process 2000 may be performed by a STA or an AP. The STA or AP may support NG TB PPDU and/or NG MU PPDU generation and transmission. Example process 2000 may include steps 2002, 2004, 2006, 2008, and 2010.

As shown in FIG. 20, process 2000 may include, in step 2002, generating a PPDU including an L-LTF. For example, the PPDU may be similar to PPDU 1400 described above. In an embodiment, the PPDU may also include an L-STF, an L-SIG, an RL-SIG, and/or a U-SIG.

In step 2004, process 2000 may include selecting a subcarrier spacing of a data field of the PPDU between a first subcarrier spacing and a second subcarrier spacing to encode the data field of the PPDU. The first subcarrier spacing may be equal to a subcarrier spacing of the L-LTF. The second subcarrier spacing may be a fraction or a multiple of the subcarrier spacing of the L-LTF. In an embodiment, the second subcarrier spacing may be one-half or one-third of the subcarrier spacing of the L-LTF. In another embodiment, the second subcarrier spacing is two, three, or four times the subcarrier spacing of the L-LTF. A STA performing process 2000 may choose a higher subcarrier spacing to lower the receive latency of the PPDU. On the other hand, the STA may choose a lower subcarrier spacing to increase the spectral efficiency when transmitting the PPDU.

In an embodiment, the U-SIG may include an indication of the subcarrier spacing of the data field. In an embodiment, the U-SIG may include an indication of whether the data field is encoded using the first subcarrier spacing or the second subcarrier spacing. In another embodiment, the U-SIG may indicate a PPDU subtype. The PPDU subtype may indicate the subcarrier spacing of the data field.

In an embodiment, the PPDU may include an NG-SIG following the U-SIG. In an embodiment, instead of the U-SIG, the NG-SIG may include the indication of the subcarrier spacing of the data field. The indication may be an indication of whether the data field is encoded using the first subcarrier spacing or the second subcarrier spacing. Alternatively, the NG-SIG may indicate a PPDU subtype. The PPDU subtype may indicate the subcarrier spacing of the data field.

In an embodiment, the PPDU may include one or more NG-LTFs. Multiple NG-LTFs allow a receiving STA to decode parallel spatial streams transmitted using MIMO by a transmitting STA. In some embodiments, the number of spatial streams that a transmitting STA may transmit is limited to the number of NG-LTFs that is included in the PPDU. In some embodiments, the L-LTF may be used as the first NG-LTF of the multiple NG-LTFs. In such a case, the number of NG-LTFs may be decreased by one. In some embodiments, the STA may include more NG-LTFs than the number of spatial streams in the PPDU to further aid the receiving STA in decoding a MIMO PPDU.

In an embodiment, where the PPDU includes one or more NG-LTFs and an NG-SIG, the number of NG-LTFs in the PPDU may be included in the NG-SIG field. Alternatively, the number of spatial streams of the PPDU may be indicated in the NG-SIG field instead of the number of NG-LTFs. In such a case, the number of spatial streams indicates the number of NG-LTFs in the PPDU.

In another embodiment, the U-SIG comprises an indication of the number of NG-LTFs in the PPDU. For example, when the PPDU does not include an NG-SIG field (e.g., NG TB PPDU 1210), the number of NG-LTFs may be included in the U-SIG field. In another embodiment, the U-SIG comprises an indication of the number of spatial streams of the PPDU. The number of spatial streams may indicate the number of NG-LTFs in the PPDU.

In an embodiment, the transmitted PPDU may be a TB PPDU, an SU PPDU, an MU PPDU, or an ER SU PPDU. The bandwidth of the PPDU may be 80 MHz, 160 MHz, or 320 MHz.

Returning to FIG. 20, in step 2006, process 2000 may include generating a data payload according to the selected subcarrier spacing. In step 2008, process 2000 includes inserting the data payload into the data field of the PPDU. Process 2000 terminates in step 2010, which may include transmitting the PPDU.

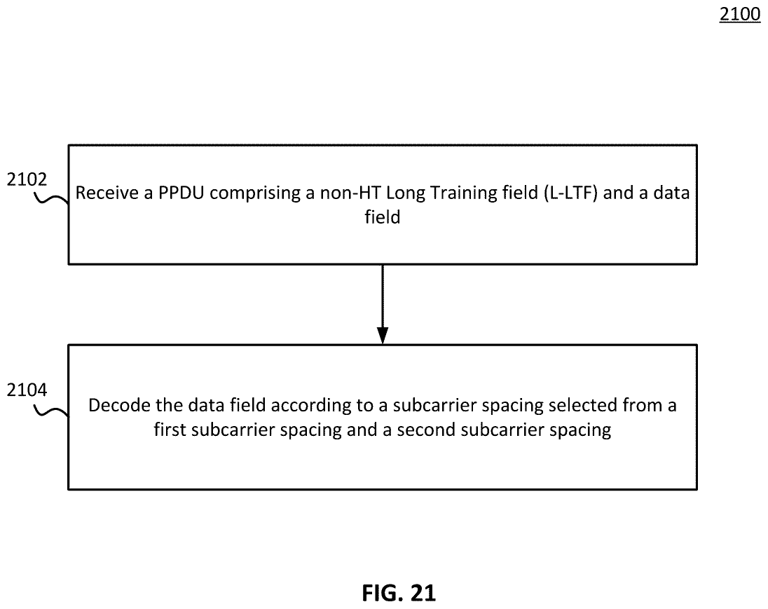

FIG. 21 illustrates an example process 2100 according to an embodiment of the present disclosure. Example process 2100 is provided for the purpose of illustration and is not limiting of embodiments. Example process 2100 may be performed by a STA or an AP. The STA or AP may support NG TB PPDU and/or NG MU PPDU reception and processing. Example process may include steps 2102 and 2104.

As shown in FIG. 21, process 2100 may include in step 2102, receiving a PPDU including an L-LTF and a data field. In an embodiment, the PPDU may further include an L-STF, an L-SIG, an RL-SIG and/or a U-SIG.

In step 2104, process 2100 may include decoding the data field according to a subcarrier spacing selected from a first subcarrier spacing and a second subcarrier spacing. The first subcarrier spacing may be equal to a subcarrier spacing of the L-LTF. The second subcarrier spacing may be a fraction or a multiple of the subcarrier spacing of the L-LTF. In an embodiment, the second subcarrier spacing may be one-half or one-third of the subcarrier spacing of the L-LTF. In another embodiment, the second subcarrier spacing is two, three, or four times the subcarrier spacing of the L-LTF.

In an embodiment, the U-SIG may include an indication of the subcarrier spacing of the data field. In an embodiment, the U-SIG may include an indication of whether the data field is encoded using the first subcarrier spacing or the second subcarrier spacing. In another embodiment, the U-SIG may indicate a PPDU subtype. The PPDU subtype may indicate the subcarrier spacing of the data field.

In an embodiment, the PPDU may include an NG-SIG following the U-SIG. In an embodiment, instead of the U-SIG, the NG-SIG may include the indication of the subcarrier spacing of the data field. The indication may be an indication of whether the data field is encoded using the first subcarrier spacing or the second subcarrier spacing. Alternatively, the NG-SIG may indicate a PPDU subtype. The PPDU subtype may indicate the subcarrier spacing of the data field.

In an embodiment, the PPDU may include one or more NG-LTFs. In an embodiment where the PPDU includes one or more NG-LTFs and an NG-SIG, a number of NG-LTFs may be included in the NG-SIG field. Alternatively, the number of spatial streams in the MIMO PPDU may be indicated in the NG-SIG field instead of an explicit number of NG-LTFs. In such case, the number of spatial streams indicates the number of NG-LTFs in the PPDU.

In an embodiment, where the PPDU includes one or more NG-LTFs and an NG-SIG, the number of NG-LTFs in the PPDU may be included in the NG-SIG field. Alternatively, the number of spatial streams of the PPDU may be indicated in the NG-SIG field instead of the number of NG-LTFs. In such a case, the number of spatial streams indicates the number of NG-LTFs in the PPDU.

In another embodiment, the U-SIG comprises an indication of the number of NG-LTFs in the PPDU. For example, when the PPDU does not include an NG-SIG field (e.g., NG TB PPDU 1210), the number of NG-LTFs may be included in the U-SIG field. In another embodiment, the U-SIG comprises an indication of the number of spatial streams of the PPDU. The number of spatial streams may indicate the number of NG-LTFs in the PPDU.

In an embodiment, the transmitted PPDU may be a TB PPDU, an SU PPDU, an MU PPDU, or an ER SU PPDU. The bandwidth of the PPDU may be 80 MHz, 160 MHz, or 320 MHz.

What is claimed is:

1. A station (STA) comprising:
one or more processors; and
memory storing instructions that, when executed by the one or more processors, cause the STA to transmit a physical layer (PHY) protocol data unit (PPDU) comprising:
a data field;
a signal field comprising parameters for demodulating the data field; and
a non-High Throughput (non-HT) long training field (L-LTF) for estimating channel equalization coefficients for the signal field,
wherein the signal field comprises an indication of a subcarrier spacing of the data field.

2. The STA of claim 1, wherein the instructions, when executed by the one or more processors, further cause the STA to select the subcarrier spacing of the data field from a set comprising a first subcarrier spacing and a second subcarrier spacing.

3. The STA of claim 2, wherein the first subcarrier spacing is equal to a subcarrier spacing of the L-LTF.

4. The STA of claim 3, wherein the second subcarrier spacing is a fraction or a multiple of the subcarrier spacing of the L-LTF.

5. The STA of claim 1, wherein the PPDU further comprises a universal signal field (U-SIG).

6. The STA of claim 5, wherein the signal field corresponds to the U-SIG.

7. The STA of claim 5, wherein the PPDU further comprises a next generation (NG) SIG field (NG-SIG) following the U-SIG.

8. The STA of claim 7, wherein the signal field corresponds to the NG-SIG.

9. The STA of claim 7, wherein the U-SIG or the NG-SIG comprises an indication of a number of NG Long Training fields (NG-LTFs) in the PPDU.

10. A station (STA) comprising:
one or more processors; and
memory storing instructions that, when executed by the one or more processors, cause the STA to receive a physical layer (PHY) protocol data unit (PPDU) comprising:
a data field;
a signal field comprising parameters for demodulating the data field; and
a non-High Throughput (non-HT) long training field (L-LTF) for estimating channel equalization coefficients for the signal field,
wherein the signal field comprises an indication of a subcarrier spacing of the data field.

11. The STA of claim 10, wherein the instructions, when executed by the one or more processors, further cause the STA to determine the subcarrier spacing of the data field, based on the indication, from a set comprising a first subcarrier spacing or a second subcarrier spacing.

12. The STA of claim 11, wherein the first subcarrier spacing is equal to a subcarrier spacing of the L-LTF.

13. The STA of claim 12, wherein the second subcarrier spacing is a fraction or a multiple of the subcarrier spacing of the L-LTF.

14. The STA of claim 10, wherein the PPDU further comprises a universal signal field (U-SIG).

15. The STA of claim 14, wherein the signal field corresponds to the U-SIG.

16. The STA of claim 14, wherein the PPDU further comprises a next generation (NG) SIG field (NG-SIG) following the U-SIG.

17. The STA of claim 16, wherein the signal field corresponds to the NG-SIG.

18. The STA of claim 16, wherein the U-SIG or the NG-SIG comprises an indication of a number of NG Long Training fields (NG-LTFs) in the PPDU.

19. A non-transitory computer-readable medium comprising instructions that, when executed by one or more processors of a station (STA), cause the STA to transmit a physical layer (PHY) protocol data unit (PPDU) comprising:
a data field;
a signal field comprising parameters for demodulating the data field; and
a non-High Throughput (non-HT) long training field (L-LTF) for estimating channel equalization coefficients for the signal field,
wherein the signal field comprises an indication of a subcarrier spacing of the data field.

20. The non-transitory computer-readable medium of claim 19, wherein the instructions, when executed by the one or more processors, further cause the STA to select the subcarrier spacing of the data field from a set comprising a first subcarrier spacing and a second subcarrier spacing.
